(19) United States
(12) Patent Application Publication
(10) Pub. No.: US 2004/0107357 A1
(43) Pub. Date: Jun. 3, 2004

(54) Apparatus and method for protecting data on computer hard disk and computer readable recording medium having computer readable programs stored therein

(76) Inventors: Young Uck Jeon, Gyunggi-do (KR); Chang Ju Lee, Seoul (KR)

Correspondence Address: CANTOR COLBURN, LLP, 55 GRIFFIN ROAD SOUTH, BLOOMFIELD, CT, 06002

(21) Appl. No.: 10/473,038

(22) PCT Filed: Mar. 5, 2002
(86) PCT No.: PCT/KR02/00372

(30) Foreign Application Priority Data
Mar. 28, 2001 (KR) 2001-16273

(51) Int. Cl. G06F 12/14

(52) U.S. Cl. 713/200

(57) ABSTRACT

Provided are data protection apparatus and method for protecting and recovering system data and user data stored in a computer hard disc from infection of a virus, a user's careless treatment, or intentional damage to a computer system, and a computer readable recording medium in which a program for performing the method in a computer system is recorded. The apparatus includes a hard disc dividing unit for dividing a hard disc area in the computer system into a system protection area, a user data area, and a system change area; a data protection unit for storing changed content in the system change area in response to a write request with respect to data stored in the system protection area and accessing both data stored in the system protection area and the changed content stored in the system change area in response to a read request with respect to data stored in the system protection area so as to determine the data corresponding to the read request, during operation of the computer system; and a data recovery unit for recovering the hard disc by deleting content from the system change area when the computer system satisfies a predetermined condition.

### TECHNICAL FIELD

The present invention relates to an apparatus and method for protecting system data and user data stored in a computer hard disc, and more particularly, to a data protection apparatus and method for protecting and recovering system data and user data stored in a computer hard disc from infection of a virus, a user's careless treatment, or intentional damage to a system, and a computer readable recording medium in which a program for performing the method in a computer is recorded.

### BACKGROUND ART

Generally, a variety of programs (software) are installed in a computer system to drive hardware of a computer such that the hardware and the software operate in organic association to execute a job desired by a user.

While using computers, it frequently happens that system data and user data are fatally damaged by attack of virus programs, users' carelessness or mistakes, or other users' malicious behaviors. Besides, an unexpected situation or installation or deletion of a particular program often causes trouble in the operation of a computer system.

The following conventional methods for protecting data stored in a computer hard disc are used to cope with trouble occurring in a computer system.

First, a vaccine program is used to protect a computer system from a virus program or to cure a computer system attacked by a virus program. This method is useful to protect a computer system from already known virus programs but is useless against new virus programs. In addition, even if a virus program has already been known, when the virus program is a vicious one, it is impossible to cure a computer system, so there is no way but to delete damaged data. Deletion of system data fatally damages operating systems, resulting in a state in which operating systems cannot operate normally.

Second, after programs necessary for a computer system are installed, images in a hard disc is stored in another recording medium (for example, CD-ROM), and the images stored in the recording medium are copied to the hard disc when trouble occurs in the computer system in order to recover damaged data. According to this method, a user needs to backup the images of the hard disc whenever installing a new program in or deleting a program from the hard disc or recording important data on the hard disc. A job of backing up the images of a hard disc to a recording medium and recovering a computer system using the backed up hard disc images requires an extra recording medium and a lot of working time, and is also very complex.

Third, data in a hard disc is automatically and periodically backed up, and data backed up at a particular time is recovered when trouble occurs in a computer system. However, since this method is centered on user data, it is difficult to protect system data and to recover the entire hard disc or a large amount of data.

Fourth, system data in a hard disc is protected using particular hardware. In order to use this method, an extra hardware item is required. In addition, the extra hardware needs to be installed at a main board slot after the body of a computer system is opened, and is complex and inconvenient. More over, this method provides a protection means for system data which is not frequently changed but does not provide an appropriate protection and/or recovery means for user data which is frequently changed.

### DISCLOSURE OF THE INVENTION

To overcome the above-described problems, it is a first object of the present invention to provide an apparatus for protecting data stored in a computer hard disc, in which system data and user data can be protected and recovered from damage to a computer system due to infection of a virus program, a user's carelessness or mistake, or malicious use during use of the computer system without using extra hardware so that the computer system can stably operate in an optimal state.

It is a second object of the present invention to provide a method for protecting data stored in a computer hard disc, through which system data and user data can be protected and recovered from damage to a computer system due to infection of a virus program, a user's carelessness or mistake, or malicious use during use of the computer system without using extra hardware so that the computer system can stably operate in an optimal state.

It is a third object of the present invention to provide a computer readable recording medium on which a program for performing the method in a computer is recorded.

To achieve the first object of the present invention, there is provided an apparatus for protecting data stored in a hard disc of a computer system. The apparatus includes a hard disc dividing unit for dividing a hard disc area in the computer system into a system protection area, a user data area, and a system change area; a data protection unit for storing changed content in the system change area in response to a write request with respect to data stored in the system protection area and accessing both data stored in the system protection area and the changed content stored in the system change area in response to a read request with respect to data stored in the system protection area so as to determine the data corresponding to the read request, during operation of the computer system; and a data recovery unit for recovering the hard disc by deleting content from the system change area when the computer system satisfies a predetermined condition.

The system change area is subdivided into a plurality of sub system change areas, each sub system change area stores changed content generated during a corresponding period of time. The data recovery unit recovers the hard disc by deleting content from all sub system change areas following a sub system change area selected by a user when the computer system satisfies the predetermined condition.

The data protection unit includes a user data protector for backing up a file among files stored in the user data area to a predetermined recording medium in response to a write request with respect to the file for which backup is requested during operation of the computer system. The data recovery unit includes a user data recoverer for recovering the data of the user data area using user data backed up to the predetermined recording medium in response to a user data recovery request.

The data protection unit includes a used change area amount display unit for periodically checking the used amount of the system change area and displays the used amount of the system change area on a monitor of the computer system.

The apparatus further includes an environment information management unit for receiving environment information including hard disc recovery schedule information, a manager password, and protection mode/non-protection mode change information from a user and managing the environment information.

To achieve the second object of the present invention, there is provided a method for protecting data stored in a hard disc of a computer system. The method includes the steps of (a) dividing a hard disc area in the computer system into a system protection area, a user data area, and a system change area; (b) operating the computer system in a protection mode; (c) storing changed content in the system change area in response to a write request with respect to data stored in the system protection area and accessing both data stored in the system protection area and the changed content stored in the system change area in response to a read request with respect to data stored in the system protection area so as to determine the data corresponding to the read request, in the protection mode; and (d) recovering the hard disc by deleting content from the system change area when the computer system satisfies a predetermined condition.

The system change area is subdivided into a plurality of sub system change areas, each sub system change area stores changed content generated during a corresponding period of time, and the step (d) includes recovering the hard disc by deleting content from all sub system change areas following a sub system change area selected by a user when the computer system satisfies the predetermined condition.

The step (c) includes the step of (c1) backing up a file among files stored in the user data area to a predetermined recording medium after completing write of the file in response to a write request with respect to the file for which backup is requested during operation of the computer system, and the step (d) includes the step of (d1) recovering the data of the user data area using user data backed up to the predetermined recording medium in response to a user data recovery request.

The method further includes the step of (e) converting the mode of the computer system into a non-protection mode according to the user's selection and changing the data stored in the system protection area, for example, installing or deleting a program, changing system data, or backing up important user data stored in the user data area to the system protection area.

To achieve the third object of the present invention, there is provided a computer readable recording medium in which a program, through which a computer system operates such as to protect data stored in a hard disc thereof, is recorded. The program includes a hard disc dividing module for dividing a hard disc area in the computer system into a system protection area, a user data area, and a system change area; a data protection module for storing changed content in the system change area in response to a write request with respect to data stored in the system protection area and accessing both data stored in the system protection area and the changed content stored in the system change area in response to a read request with respect to data stored in the system protection area so as to determine the data corresponding to the read request, during operation of the computer system; and a data recovery module for recovering the hard disc by deleting content from the system change area when the computer system satisfies a predetermined condition.

The system change area is subdivided into a plurality of sub system change areas, each sub system change area stores changed content generated during a corresponding period of time, and the data recovery module recovers the hard disc by deleting content from all sub system change areas following a sub system change area selected by a user when the computer system satisfies the predetermined condition.

The data protection module includes a user data protection module for backing up a file among files stored in the user data area to a predetermined recording medium after completing write of the file in response to a write request with respect to the file for which backup is requested during operation of the computer system, and the data recovery module includes a user data recovery module for recovering the data of the user data area using user data backed up to the predetermined recording medium in response to a user data recovery request.

The data protection module includes a used change area amount display module for periodically checking the used amount of the system change area and displays the used amount of the system change area on a monitor of the computer system.

The program further includes an environment information management module for receiving environment information including hard disc recovery schedule information, a manager password, and protection mode/non-protection mode change information from a user and managing the environment information.

### BRIEF DESCRIPTION OF THE DRAWINGS

FIG. 1 is a block diagram of an entire apparatus for protecting data stored in a computer hard disc according to a first embodiment of the present invention.

FIG. 2 is a conceptional diagram of hard disc areas divided according to the first embodiment of the present invention.

FIG. 3 is a diagram of a mechanism for protecting hard disc data according to the first embodiment of the present invention.

FIG. 4 is a diagram showing that a system change area can be divided into a plurality of sub system change areas according to a second embodiment of the present invention.

FIG. 5 is a flowchart of a method for protecting data stored in a computer hard disc according to an embodiment of the present invention.

FIG. 6 is a detailed flowchart of a step of operating in a manager mode shown in FIG. 5.

FIG. 7 is a detailed flowchart of a step of executing a program in a protection mode shown in FIG. 5.

FIG. 8 is a flowchart of a procedure through which a computer system in which an apparatus for protecting data stored in a computer hard disc according to the present invention is implemented is booted.

### BEST MODE FOR CARRYING OUT THE INVENTION

Hereinafter, preferred embodiments of an apparatus for protecting data stored in a computer hard disc according to the present invention will be described in detail with reference to the attached drawings.

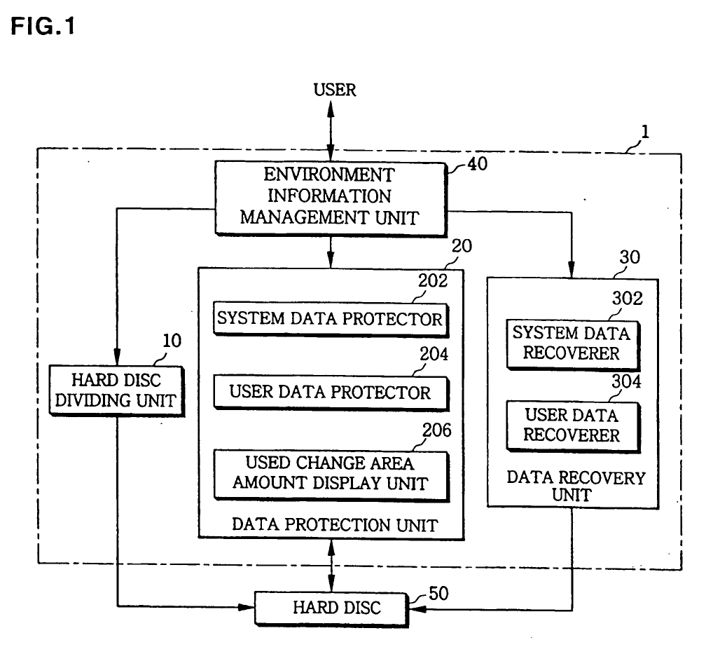

Referring to FIG. 1, an apparatus 1 for protecting data stored in a hard disc 50 of a computer system according to the present invention (hereinafter, referred to as an hard disc protection apparatus 1) includes a hard disc dividing unit 10, a data protection unit 20, a data recovery unit 30, and environment information management unit 40. Each element of the hard disc protection apparatus 1 is implemented as a combination of hardware and software of the computer system including the hard disc 50. Hereinafter, software corresponding to the hard disc dividing unit 10 is referred to as an installation program, and software corresponding to the environment information management unit 40, the data recovery unit 30, and the data protection unit 20 is referred to as a hard disc protection program.

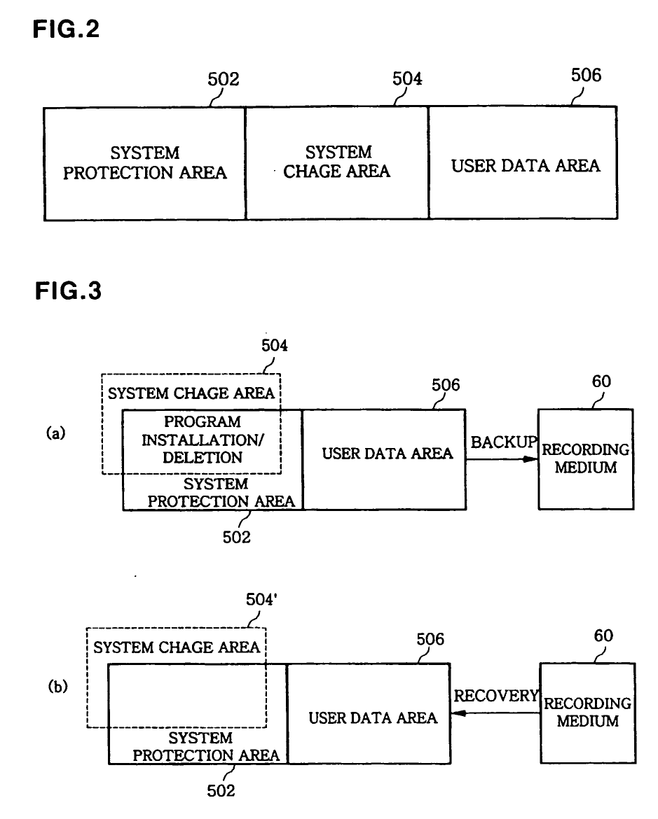

The hard disc dividing unit 10 receives information about the size of each area from a user and divides the entire area of the hard disc 50 into a system protection area 502, a user data area 506, and a system change area 504, as shown in FIG. 2. The system protection area 502 stores data whose content is desired by the user not to be changed, for example, system programs such as operating systems and application programs having a long version-up period. The user data area 506 stores user data which is frequently changed and for which the latest data is more important than initial data. The system change area 504 stores changed content when the data stored in the system protection area 502 is changed. It is preferable that the hard disc dividing unit 10 is driven when the hard disc protection program is installed in the computer system.

The data protection unit 20 is provided for protecting the data stored in the system protection area 502 and the user data area 506 from being damaged by mistake or on purpose during operation of the computer system. The data protection unit 20 includes a system data protector 202, a user data protector 204, and a used change area amount display unit 206.

The system data protector 202 and the user data protector 204 operate when a program executed in the computer system access the hard disc 50 to write data to or read data from the hard disc 50. More specifically, the system data protector 202 stores data reflecting changed content in the system change area 504 in response to a write request to change the data stored in the system protection area 502. In addition, the system data protector 202 determines data corresponding to a read request with respect to the data stored in the system protection area 502 using the data stored in the system protection area 502 and the changed content reflected on the system change area 504 and sends the determined data to a program requesting the read. Referring to FIG. 3(a), the system change area 504 functions as a transparent protective screen for the system protection area 502. Accordingly, in response to a request from a program executed in the computer system to change system data, changed content of the data stored in the system protection area 502 is reflected on only the system change area 504, and the original data stored in the system protection area 502 is securely maintained.

During operation of the computer system, in response to a write request with respect to a file, for which backup is requested, among files stored in the user data area 506, the user data protector 204 backs up the file to a predetermined recording medium 60 after writing of the file is completed. Here, the predetermined recording medium 60 may be a predetermined area in the hard disc 50, an extra storage device provided in the computer system, or a server on a network. Backup conditions, such as the names of folders to be backed up, the extension names of files to be backed up, and the extension names of files to be excluded from backup, which are set by a user, can be stored in advance, and if a request to store a file in the user data area 506 is generated, the backup conditions are checked to determine whether or not to back up the file.

The used change area amount display unit 206 periodically checks the used amount of the system change area 504 and displays the used amount of the system change area 504 on a monitor of the computer system. The used change area amount display unit 206 displays a blue status check window on the monitor when the used amount of the system change area 504 is no greater than 90% and displays a red status check window when the used amount exceeds 90% so that a user can easily determine a time to recover system data.

The data recovery unit 30 includes a system data recoverer 302 which recovers system data by deleting content stored in the system change area 504 when the computer system satisfies predetermined conditions and a user data recoverer 304 which recovers data in the user data area 506 in response to a user data recovery request by using user data backed up to the predetermined recording medium 60. As shown in FIG. 3(b), by deleting content from a system change area 504′, the system change area 504′ is made to function as a new transparent protective screen for the system protection area 502.

The environment information management unit 40 receives environment information including hard disc recovery schedule information, a manager password, and protection mode/non-protection mode change information from a user, manages the environment information, and controls the operations of the data protection unit 20 and the data recovery unit 30 according to the environment information. The environment information management unit 40 controls the access of a user by compare a password input by user with a manager password set in advance and receives environment information from a user permitted an access or changes existing environment information. In addition, the environment information management unit 40 can control the data recovery unit 30 to operate in response to an immediate recovery request from a user or control the computer system to operate in a state, in which the data protection unit 20 has not been operated, in response to a request to convert a mode into a non-protection mode.

The system data recoverer 302 checks the hard disc recovery schedule information when the computer system is booted and recovers system data when the conditions of the hard disc recovery schedule information are satisfied.

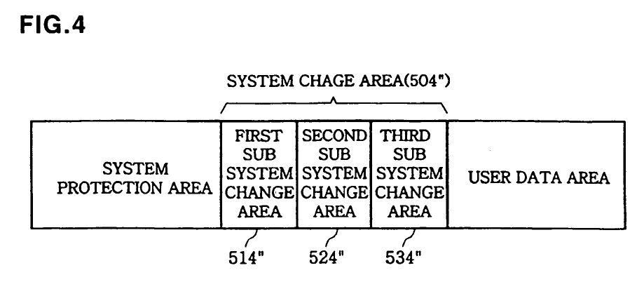

In a second embodiment of an apparatus for protecting data stored in a computer hard disc according to the present invention, the hard disc division unit 10 subdivides a system change area 504″ into first through third sub system change areas 514″, 524″, and 534″, as shown in FIG. 4. In each of the first through third sub system change areas 514″, 524″, and 534″ is stored changed content during a corresponding period of time. In case that the computer system meet a predetermined condition, for example, a time when the computer system is booted corresponds to a hard disc recovery schedule or a user selects an “immediate recovery” in a manager mode, the data recovery unit 30 deletes content stored in all sub system change areas following a sub system change area 514″, 524″, or 534″ which is selected by a user or determined in advance in accordance with the environment information, thereby recovering system data of the hard disc 50.

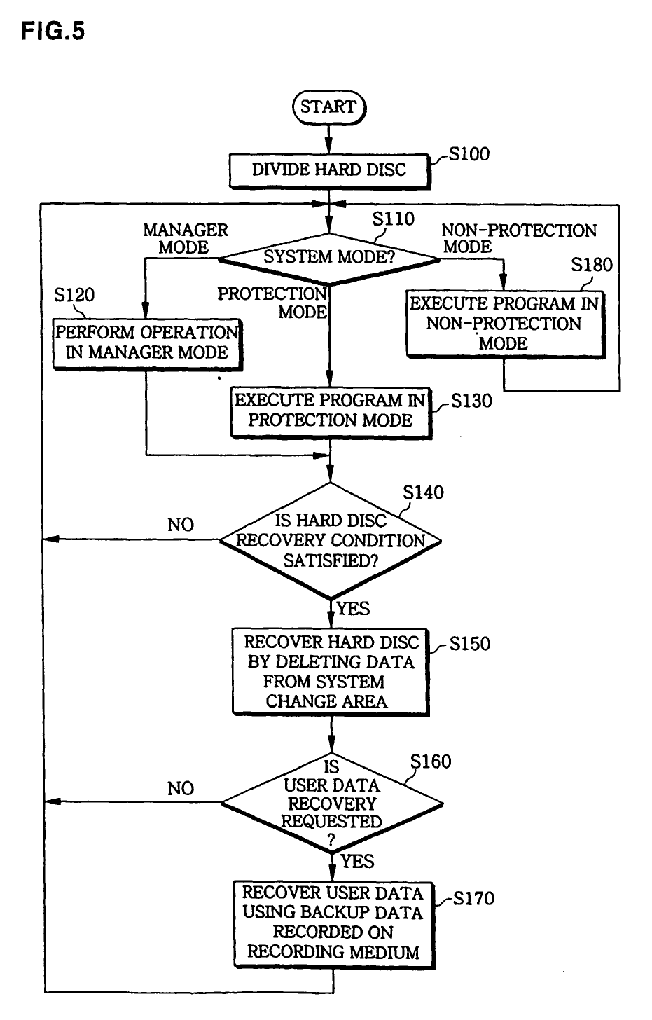

Hereinafter, a method for protecting data stored in a computer hard disc according to the present invention will be described with reference to FIGS. 5 through 7.

When a hard disc protection program is installed in a computer system, an installation program receives information about the size of each area from a user and divides the area of the hard disc 50 into the system protection area 502, the user data area 504, and the system change area 506 in step S100.

Thereafter, the hard disc protection program manages the computer system in a manager mode, a protection mode, or a non-protection mode in step S110.

A user can operate the computer system in a manager mode by inputting a previously set manager password when the computer system is booted in step S120. Alternatively, it can be set in advance that the computer system automatically operates in the manager mode whenever it is booted. In the manager mode, the hard disc protection program receives environment information including hard disc recovery schedule information, a manager password, and protection mode/non-protection mode change information from the user and manages the environment information or changes existing environment information. In addition, the hard disc protection program can perform data recovery in response to an immediate recovery request from the user or can make the computer system to be booted in a non-protection mode in response to a request to convert the manager mode into the non-protection mode.

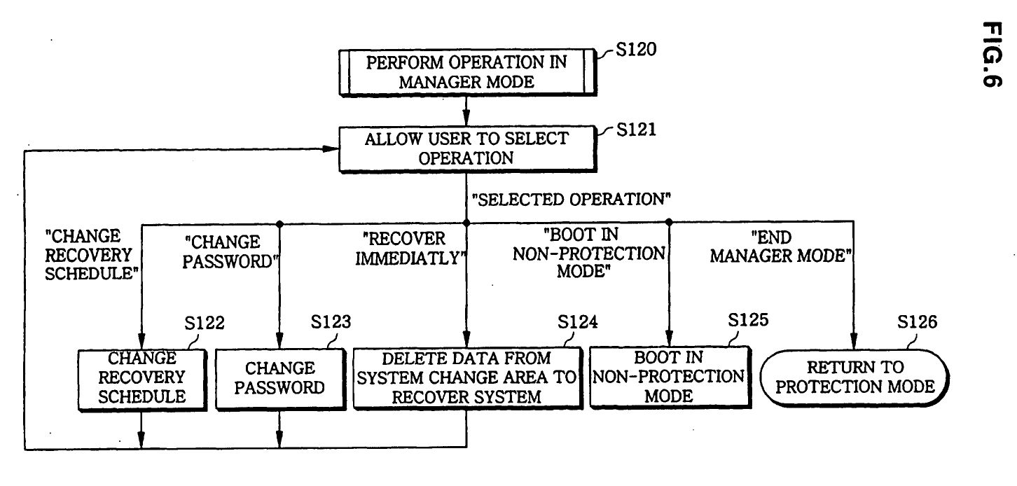

In the manager mode, the hard disc protection program provides a menus including “Change recovery schedule”, “Change password”, “Recover immediately”, “Boot in non-protection mode”, “End manager mode” and so on to allow the user to select a desired operation in step S121. Referring to FIG. 6, when the user selects “Change recovery schedule”, the hard disc protection program receives a time when the hard disc 50 is recovered from the user and manages the received time as the environment information in step S122. When the user selects “Change password”, the hard disc protection program receives a manager password necessary for accessing to the manager mode from the user and manages the received password as the environment information in step S123. When the user selects “Recover immediately”, the hard disc protection program deletes data from the system change area 506 at a current time to recover system data in one lump in step S124. When the user selects “Boot in non-protection mode”, the computer system can be newly booted in the non-protection mode in step S125. When the user selects “End manager mode”, operation in the manager mode ends in step S126.

Either if the user does not perform operation in the manager mode when the computer system is booted or if operation in the manager mode ends, operating systems of the computer system are driven in the protection mode. Thereafter, the computer system executes the operating systems and application programs in the protection mode to perform jobs desired by the user in step S130.

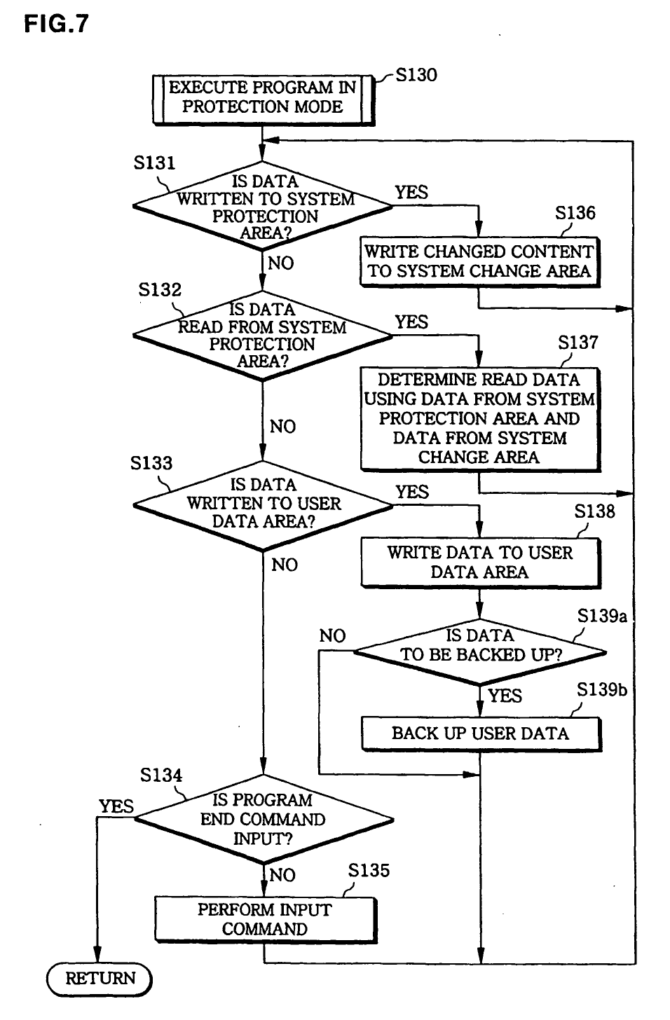

Referring to FIG. 7, when a program executed in the computer system changes data stored in the system protection area 502 in step S131, the hard disc protection program reflects changed content on the system change area 504 in step S136. When a program executed in the computer system accesses data stored in the system protection area 502 in step S132, the hard disc protection program accesses data stored in the system protection area 502 referring to the changed content reflected on the system change area 504 in step S137.

When a program executed in the computer system requests to write data with respect to a file stored in the user data area 506 in step S133, the hard disc protection program writes data to the user data area 506 in step S138 and determines whether the file needs a backup in step S139a. If it is determined that the file needs a backup, the hard disc protection program backs up the file to the predetermined recording medium 60 in step S139b.

As described above, commands such as write to system protection area, read from system protection area, and write to user data area are performed until a program end command is input in steps S134 and S135.

Referring back to FIG. 5, when the computer system meets a predetermined condition, for example, when “Recover immediately” is selected in the manager mode or when a booting time of the computer system corresponds to the hard disc recovery schedule information, system data of the hard disc 50 is recovered in one lump by deleting content from the system change area 504 in steps S140 and S150. Alternatively, the system change area 504″ can be subdivided into a plurality of first through third sub system change areas 514″, 524″, and 534″, and changed content of system data during a period of time corresponding to each sub system change area 514″, 524″, or 534″ can be stored in the sub system change areas 514″, 524″, or 534″. In this case, if the computer system meets a predetermined condition, content, which is stored in all sub system change areas following a sub system change area that is selected by the user or determined in accordance with the environment information in advance, is removed so that the system data of the hard disc 50 at a particular time point can be recovered.

During operation of the computer system, if the user request a user data recovery in step S160, the hard disc protection program recovers data in the user data area 506 using user data backed up to a recording medium in advance in step S170.

If the user selects the non-protection mode in the manager mode, the computer system is booted in a state where the hard disc protection program does not operate, that is, where a transparent screen is removed, in step S180. Accordingly, the user can change data in the system protection are 502 without being restrained by the system change area 504 in the non-protection mode. For example, the user can install or delete a program, change system data, or backs up important user data stored in the user data area 506 to the system protection area 502.

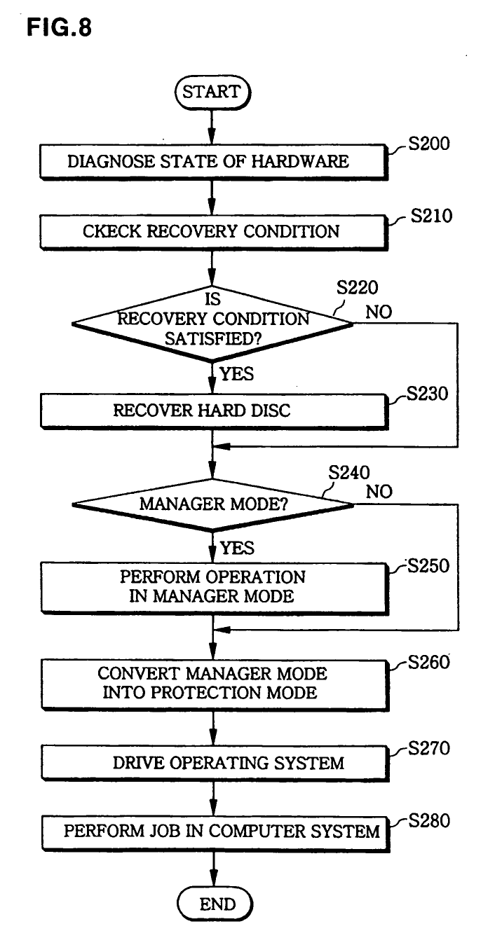

FIG. 8 is a flowchart of a procedure through which a computer system in which an apparatus for protecting data stored in a computer hard disc according to the present invention is implemented is booted.

Referring to FIG. 8, if power is applied to the computer system, diagnosis of hardware resources of the computer system is performed in S200. Next, a part (a system data recovery module) of a hard disc protection program is loaded onto memory, environment information is derived, and it is determined whether a booting time point corresponds to a hard disc recovery schedule information, which is set in advance, in step S210.

If the booting time point corresponds to the hard disc recovery schedule information, the hard disc protection program deletes content from the system change area 504, thereby recovering system data in a hard disc in one lump in steps S220 and S230. Alternatively, if a system change area 504″ is subdivided into a plurality of first through third sub system change areas 514″, 524″, and 534″, the hard disc protection program can recover the system data of the hard disc at a particular time point by deleting content which is stored in all sub system change areas following a sub system change area 514″, 524″, or 534″ that is selected by the user or determined in accordance with the environment information in advance.

When the computer system is booted, the hard disc protection program requires the user to input a manager password which is set in advance such that the computer system can be operated in a manager mode if the input password is authenticated. This is referred to as a “manual manager mode”. Alternatively, the hard disc protection program can be set in advance by the user such that the computer system automatically operates in the manager mode. This is referred to as an “automatic manager mode”. In the manager mode, the hard disc protection program receives environment information including hard disc recovery schedule information, manager password, and protection mode/non-protection mode charge information from the user and manages the environment information or changes existing environment information. In addition, in the manager mode, the hard disc protection program can perform data recovery in response to an immediate recovery request from the user or can make the computer system to be booted in a non-protection mode in response to a request to convert the manager mode into the non-protection mode.

Either if the user does not perform operation in the manager mode when the computer system is booted or if operation in the manager mode ends, the manager mode is converted into the protection mode in step S260, and operating systems are driven in S270. Thereafter, the computer system executes the operating systems and application programs in the protection mode to perform jobs desired by the user in step S280.

The above embodiment of the present invention can be made into a program which can be performed in universal digital computers. The program can be recorded in a recording medium used in universal digital computers and can be executed in the computers. The recording medium may be a magnetic storage medium (e.g., ROM, a floppy disc, or a hard disc), an optical recording medium (e.g., CD-ROM or DVD), or carrier wave (e.g., transferred through Internet).

While this invention has been particularly shown and described with reference to preferred embodiments thereof, it will be understood by those skilled in the art that various changes may be made therein without departing from the scope of the invention. Therefore, the above-described embodiments will be considered not in restrictive sense but in descriptive sense only. The scope of the invention will be defined not by the above description but by the appended claims, and it will be construed that all differences made within the scope defined by the claims are included in the present invention.

### Industrial Applicability

The present invention has the following effects.

First, system data is not frequently changed after initially stored, and user data is frequently generated and changed, so the characteristics of the system data and the user data are different. The present invention provides a protection and recovery method for both two kinds of data which are different from each other, thereby effectively protecting and recovering both system data and user data.

Second, even when a particular program is installed or deleted differently from a user's intention, a system can be recovered to an initial state only by rebooting the system without performing backup, thereby remarkably reducing system recovery time.

Third, even if system data is damaged by an invasion or infection of a virus program or even if particular data is damaged by a malicious user, only data stored in a system change area, and system data stored in a system protection area can be secured from damage in the present invention.

Fourth, when it is necessary to manage a plurality of computers as in game rooms, it can be set that system protection and recovery is automatically performed at predetermined periods. Accordingly, it does not need to specially check all computers, which makes management easy.

Fifth, by managing user data in a separate area, the latest data can be maintained unlike system data which is recovered in one lump when a recovery condition is satisfied.

Sixth, when a computer system is unstable or has trouble, the computer system can be recovered to a state at a particular time where the computer system operates normally instead of an initial installation state. Accordingly, it becomes more convenient for users to recover data.

What is claimed is:

1. An apparatus for protecting data stored in a hard disc of a computer system, the apparatus comprising:
a hard disc dividing unit for dividing a hard disc area in the computer system into a system protection area, a user data area, and a system change area;
a data protection unit for storing changed content in the system change area in response to a write request with respect to data stored in the system protection area and accessing both data stored in the system protection area and the changed content stored in the system change area in response to a read request with respect to data stored in the system protection area so as to determine the data corresponding to the read request, during operation of the computer system; and
a data recovery unit for recovering the hard disc by deleting content from the system change area when the computer system satisfies a predetermined condition.

2. The apparatus of claim 1, wherein the system change area is subdivided into a plurality of sub system change areas, each sub system change area stores changed content generated during a corresponding period of time, and
the data recovery unit recovers the hard disc by deleting content from all sub system change areas following a sub system change area selected by a user when the computer system satisfies the predetermined condition.

3. The apparatus of claim 1 or 2, wherein the data protection unit comprises a user data protector for backing up a file among files stored in the user data area to a predetermined recording medium in response to a write request with respect to the file for which backup is requested during operation of the computer system, and
the data recovery unit comprises a user data recoverer for recovering the data of the user data area using user data backed up to the predetermined recording medium in response to a user data recovery request.

4. The apparatus of claim 1 or 2, wherein the data protection unit comprises a used change area amount display unit for periodically checking the used amount of the system change area and displays the used amount of the system change area on a monitor of the computer system.

5. The apparatus of claim 1 or 2, further comprising an environment information management unit for receiving environment information including hard disc recovery schedule information, a manager password, and protection mode/non-protection mode change information from a user and managing the environment information.

6. A method for protecting data stored in a hard disc of a computer system, the method comprising the steps of:
(a) dividing a hard disc area in the computer system into a system protection area, a user data area, and a system change area;
(b) operating the computer system in a protection mode;
(c) storing changed content in the system change area in response to a write request with respect to data stored in the system protection area and accessing both data stored in the system protection area and the changed content stored in the system change area in response to a read request with respect to data stored in the system protection area so as to determine the data corresponding to the read request, in the protection mode; and
(d) recovering the hard disc by deleting content from the system change area when the computer system satisfies a predetermined condition.

7. The method of claim 6, wherein the system change area is subdivided into a plurality of sub system change areas, each sub system change area stores changed content generated during a corresponding period of time, and
the step (d) comprises recovering the hard disc by deleting content from all sub system change areas following a sub system change area selected by a user when the computer system satisfies the predetermined condition.

8. The method of claim 6 or 7, wherein the step (c) comprises the step of (c1) backing up a file among files stored in the user data area to a predetermined recording medium in response to a write request with respect to the file for which backup is requested during operation of the computer system, and
the step (d) comprises the step of (d1) recovering the data of the user data area using user data backed up to the predetermined recording medium in response to a user data recovery request.

9. The method of claim 6 or 7, further comprising the step of (e) converting the mode of the computer system into a non-protection mode according to the user's selection and changing the data stored in the system protection area.

10. A computer readable recording medium in which a program, through which a computer system operates such as to protect data stored in a hard disc thereof, is recorded, the program comprising:
a hard disc dividing module for dividing a hard disc area in the computer system into a system protection area, a user data area, and a system change area;
a data protection module for storing changed content in the system change area in response to a write request with respect to data stored in the system protection area and accessing both data stored in the system protection area and the changed content stored in the system change area in response to a read request with reflect to data stored in the system protection area so as to determine the data corresponding to the read request, during operation of the computer system; and
a data recovery module for recovering the hard disc by deleting content from the system change area when the computer system satisfies a predetermined condition.

11. The computer readable recording medium of claim 10, wherein the system change area is subdivided into a plurality of sub system change areas, each sub system change area stores changed content generated during a corresponding period of time, and the data recovery module recovers the hard disc by deleting content from all sub system change areas following a sub system change area selected by a user when the computer system satisfies the predetermined condition.

12. The computer readable recording medium of claim 10 or 11, wherein the data protection module comprises a user data protection module for backing up a file among files stored in the user data area to a predetermined recording medium in response to a write request with respect to the file for which backup is requested during operation of the computer system, and
the data recovery module comprises a user data recovery module for recovering the data of the user data area using user data backed up to the predetermined recording medium in response to a user data recovery request.

13. The computer readable recording medium of claim 10 or 11, wherein the data protection module comprises a used change area amount display module for periodically checking the used amount of the system change area and displays the used amount of the system change area on a monitor of the computer system.

14. The computer readable recording medium of claim 10 or 11, wherein the program further comprises an environment information management module for receiving environment information including hard disc recovery schedule information, a manager password, and protection mode/non-protection mode change information from a user and managing the environment information.
